(19) United States
(12) Patent Application Publication
(10) Pub. No.: US 2018/0135895 A1
(43) Pub. Date: May 17, 2018

(54) ADSORPTION TYPE COOLING APPARATUS USING NANOPOROUS ALUMINOPHOSPHATE AND OPERATION METHOD THEREOF

(71) Applicant: KOREA INSTITUTE OF ENERGY RESEARCH, Daejeon (KR)

(72) Inventors: Kanghee CHO, Daejeon (KR); Jong-Nam Kim, Daejeon (KR); Hee Tae Beum, Daejeon (KR); Sang Kyum Kim, Daejeon (KR); Eunkyung Lee, Seoul (KR); Hyun-uk Kim, Daejeon (KR); Sang-Sup Han, Daejeon (KR); Hyung Chul Yoon, Daejeon (KR); Dong-Woo Cho, Daejeon (KR)

(21) Appl. No.: 15/654,742

(22) Filed: Jul. 20, 2017

(30) Foreign Application Priority Data
Nov. 14, 2016 (KR) 10-2016-0150833

(51) Int. Cl. F25B 17/08; C01F 7/06

(52) U.S. Cl. CPC F25B 17/08; C01F 7/0673

(57) ABSTRACT

Disclosed are an adsorption type cooling apparatus using nanoporous aluminophosphate as a water vapor adsorbent, and an operation method thereof. Specifically, the adsorption type cooling apparatus uses nanoporous aluminophosphate exhibiting a high dynamic water vapor adsorption capacity as a water vapor adsorbent. The adsorption type cooling apparatus includes at least two adsorption towers containing a water vapor adsorbent, a condenser alternately connected to the adsorption towers, and an evaporator alternately connected to the adsorption towers, wherein the water vapor adsorbent is nanoporous aluminophosphate containing aluminum, phosphorous, and oxygen.

### CROSS REFERENCE TO RELATED APPLICATION

The present application claims priority to Korean Patent Application No. 10-2016-0150833, filed Nov. 14, 2016, the entire contents of which is incorporated herein for all purposes by this reference.

### BACKGROUND OF THE INVENTION

### Field of the Invention

The present invention generally relates to an adsorption type cooling apparatus using nanoporous aluminophosphate as an adsorbent, and an operation method thereof. More particularly, the present invention relates to an adsorption type cooling apparatus using nanoporous aluminophosphate exhibiting a high dynamic water vapor adsorption capacity, and an operation method thereof.

### Description of the Related Art

Efficient use of energy has become a major global issue due to recent increasing energy demands and global climate change. With recent developments in energy saving technologies, it has become possible to easily recycle and reuse hot waste heat. Nevertheless, low-temperature waste heat having a temperature equal to or lower than 90° C. is discarded because there is no beneficial applications to use the low-temperature waste heat.

Especially, technologies for effectively using low-temperature waste heat having a temperature of from 60° C. to 90° C., generated from various industrial sites, and renewable energy generated by solar collectors or the like in summer have attracted attention.

With recent economic development, there is a rapidly increasing demand for living and working in pleasant surroundings. However, since global temperature rise attributable to global warming has occurred, cooling demands are significantly increased. Thus, 15% of the total electric power produced in the world is consumed by electric air-compression refrigeration or cooling systems that uses Freon refrigerants. This accounts for 45% of the total energy consumption of households and commercial buildings. For this reason, problems such as power shortages in summer, greenhouse gas emissions, and ozone depletion are likely to occur.

An adsorption type cooling apparatus is operated by a low-temperature (60 to 90° C.) heat source and uses water, methanol, ammonia, or the like as a refrigerant to produce energy for air-conditioning (5 to 15° C.) or energy for refrigeration or cooling (−20 to 0° C.). That is, such an adsorption type cooling apparatus is a powerless eco-friendly cooling system to replace an electric air-compression Freon air-conditioner. The adsorption type cooling apparatus may use low-temperature waste heat, hot water produced by a solar collector, district heating water, geothermal heat, waste heat of a fuel cell, or heat generated when cooling a combustion engine, as a driving heat source.

An adsorption type cooling apparatus includes an adsorption tower for adsorbing a refrigerant, an evaporator, and a condenser. Cooling energy is produced by the evaporator due to removal of vaporization heat while the refrigerant (water) vaporizes into vapor in the evaporator, moves to the adsorption tower, and is adsorbed on an adsorbent in the adsorption tower. When the refrigerant adsorbed on the adsorbent in the adsorption tower is saturated, a heat source such as low-temperature waste heat, renewable energy, or district heating water is supplied to the adsorption tower so that the refrigerant adsorbed on the adsorbent can be desorbed from the adsorbent and then move to the condenser. After that the refrigerant vapor is liquefied, the refrigerant moves to the evaporator. This cycle is continuously performed. For continuous generation of cooling energy, two or more adsorption towers are used. In this case, one adsorption tower undergoes a refrigerant adsorption process, and the other adsorption tower undergoes an adsorbent regeneration process in which the adsorption tower is heated to regenerate the adsorbent.

For example, when water that is the most eco-friendly refrigerant is used, it is adsorbed on a specific adsorbent at a temperature of 35° C. and a vapor pressure of about 12 Torr, and is desorbed from the adsorbent at a temperature of 80° C. and a vapor pressure of about 42 Torr. Through this cycle, cold air of 10 to 15° C. can be produced in the evaporator.

As a refrigerant adsorbing material, a nanoporous material such as silica gel, activated carbon, zeolite, or Metal-Organic Framework (MOF) can be used. Commercial adsorption type cooling apparatuses typically use water (as a refrigerant) and silica gel (as an adsorbent).

Silica gel tends to start adsorbing a refrigerant at a low vapor pressure due to its hydrophilic property. However, it shows an extremely small adsorption and desorption difference per unit amount of an adsorbent, for example, 0.08 g-water/g-sorbent at a relative humidity P/P₀ within a range of from 0.1 to 0.3, which is an operation condition of an adsorption type cooling apparatus. Therefore, when silica gel is used as an adsorbent, there is a problem that the size and price of the adsorption type cooling apparatus are increased. In addition, in the case of RD type silica gel (manufactured by Fuji Silysia Chemical Ltd.) that is a typical commercially used adsorbent, it exhibits a small water vapor adsorption and desorption difference of 10 wt % or lower at a relative humidity P/P₀) within a range of from 0.1 to 0.3, which is an operation condition thereof.

Mesoporous silica exhibits a high adsorption rate, for example, 60 wt % or higher at a room temperature of 25° C. However, the adsorption occurs dominantly under a condition of a relative humidity P/P₀ of 0.5 or higher.

In contrast, zeolite having FAU (Faujasite) structure or LTA (Linde Type A) structure exhibits a maximum adsorption rate of 22 to 35 wt % at a room temperature of 25° C. and a low relative humidity of 0.05 or lower. However, this type of zeolite is problematic in terms of high desorption temperature.

In addition, FAM-Z01, which is one product of the AQSOA™ series manufactured by Mitsubishi Chemical Ltd. (Japan), contains aluminum and phosphorus as main components unlike conventional zeolite consisting of aluminum and silicon, and uses ferroaluminophosphate zeolite (FAPO₄-5) that is weakly hydrophilic as a water vapor absorbent. This technology introduces iron (Fe) into the lattice structure of AlPO₄-5, thereby obtaining an S-shaped adsorption isotherm of water vapor within an operation range (P/P₀=0.1 to 0.3) of an adsorption type refrigerator. FAM-Z01 is known to exhibit an adsorption and desorption difference of 0.17 g-water/g-sorbent under a condition of an operation range of P/P₀=0.1 to 0.3.

FAM-Z02, which is another product of the AQSOA™ product series manufactured by Mitsubishi Chemical Ltd., (Japan) is silicoaluminophosphate zeolite (SAPO₄-34)) . FAM-Z02 exhibits a greatly higher adsorption amount (0.30 g of H₂O per 1 g of absorbent) under conditions of a constant temperature and a relative humidity (P/P₀) of 0.3 or lower as compared with FAM-Z01 (FAPO₄-5 series), but is disadvantageous in that most of the adsorption occurs at low pressures due to its extremely high adsorbability due to silicon contained in the framework of FAM-Z02. Therefore, it is known to actually exhibit a much lower dynamic water vapor adsorption capacity (i.e. difference between an adsorption rate and a desorption rate) under practical operation conditions of an adsorption type refrigerator than FAM-Z01.

As described above, conventional water vapor adsorbents used in an adsorption type cooling apparatus have critical disadvantages. Therefore, there is a demand for development of a water vapor adsorbent having advantages of conventional water vapor adsorbents but eliminating disadvantages of the conventional water vapor adsorbents.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and an object of the present invention is to provide an adsorption type cooling apparatus using a water vapor adsorbent exhibiting a high adsorption performance at a room temperature and high desorption performance with less heat, and an operation method thereof.

The above and other objects, features, and advantages of the invention will be more clearly understood from the following detailed description.

In order to accomplish the above object, the present invention provides an adsorption type cooling apparatus including: at least two adsorption towers in which a water vapor adsorbent is contained; a condenser connected to the adsorption towers; and an evaporator connected to the adsorption towers, wherein the water vapor adsorbent is nanoporous aluminophosphate containing aluminum, phosphorus, and oxygen.

The water vapor adsorbent may be provided with micropores. The micropores may have a size of 0.35 to 1.0 nm, and may be regularly arranged.

The water vapor adsorbent may have a hierarchically porous structure including micropores and mesopores. The mesopores may have a size of 3.5 to 25 nm, and may be regularly or randomly arranged.

The water vapor adsorbent may exhibit a dynamic water vapor adsorption capacity of 0.2 g or higher. The dynamic water vapor adsorption capacity refers to a difference between a waver vapor adsorption capacity per 1 g of the adsorbent at a temperature of 25 to 35° C. and a pressure of 8 to 15 Torr and a water vapor adsorption capacity per 1 g of the adsorbent at a temperature of 70 to 80° C. and a pressure of 40 to 45 Torr.

In order to accomplish the objects of the invention, according to another aspect, there is provided an operation method of an adsorption type cooling apparatus, the method including: a process in which water vapor produced in an evaporator moves to an adsorption tower and is adsorbed on a water vapor adsorbent contained in the adsorption tower; a process in which hot water having a temperature of 70 to 80° C. is supplied to the adsorption tower so that the water vapor on the water vapor adsorbent is desorbed; a process in which the desorbed water vapor moves to a condenser and condenses in the condenser; and a process in which the condensed water vapor moves to the evaporator, wherein the water vapor adsorbent is nanoporous aluminophosphate containing aluminum, phosphorous, and oxygen.

The water adsorbent may be provided with micropores. The micropores may have a size of 0.35 to 1.0 nm and may be regularly arranged.

The water vapor adsorbent may have a hierarchically porous structure including micropores and mesopores. The mesopores may have a size of 3.5 to 25 nm and may be regularly or randomly arranged.

The water vapor adsorbent may have a dynamic water vapor adsorption capacity of 0.2 g or higher, in which the dynamic water vapor adsorption capacity refers to a difference between a water vapor adsorption capacity at a temperature of 30 to 40° C. and a pressure of 8 to 15 Torr per 1 g of the adsorbent, and a water vapor adsorption capacity at a temperature of 70 to 80° C. and a pressure of 40 to 45 Torr per 1 g of the adsorbent.

As described above, the present invention enables effective use of industrial waste heat by using a water vapor adsorbent having a high adsorption performance and durability and being little deteriorated with time.

In addition, the present invention is advantageous in terms of minimum vibration and noise due to a small driving unit. Furthermore, the present invention uses water as a refrigerant, thereby preventing environment destruction (i.e. ozone depletion) attributable to Freon-based refrigerants. Furthermore, the present invention generates a less non-condensable gas such as hydrogen compared to conventional adsorption type cooling apparatuses, thereby saving cost for maintaining a vacuum degree.

The advantages and features of the invention are not limited to those described above, but those skilled in the art would clearly understand that other advantages and features not described above can be obtained from the following detailed description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic diagram of an adsorption type cooling apparatus according to one embodiment of the invention;

FIG. 2 is a graph of adsorption isotherms (at 35° C.) of water vapor on an adsorbent according to one embodiment of the invention and a conventional silicon-impregnated absorbent;

FIG. 3 is a graph of adsorption isotherms of water vapor on various adsorbents, including an adsorbent according to one embodiment of the invention, at various temperatures and pressures;

FIG. 4 is a graph showing dynamic adsorption capacities of water vapor on a water vapor adsorbent according a one embodiment of the invention and a conventional silicon-impregnated water vapor adsorbent; and

FIG. 5 is a graph illustrating the results of X-ray diffractometry of a water vapor adsorbent used in the invention.

### DETAILED DESCRIPTION OF THE INVENTION

Hereinbelow, exemplary embodiments of the present invention will be described in detail with reference to the accompanying drawings. The exemplary embodiments are provided for illustrative purposes, and those skilled in the art will appreciate that the scope of the invention is not limited to the exemplary embodiments described below.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, when the meanings of terms contradict each other.

A description on elements that are not directly relevant to the invention is omitted to provide a clear description on the invention shown in the accompanying drawings, and like reference characteristics refer to like elements throughout the following detailed description. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof. In addition, it will be understood that the terms “unit”, “part”, “portion”, etc. when used in this specification specify a functional unit or block of performing a specific function.

It will be understood that, although the terms “first”, “second” etc. may be used herein to describe various steps, these steps should not be limited by these terms. These terms are not used to describe a sequence of steps but only used to distinguish one step from another step. Unless a specific sequence is stated, the steps may be performed in any order regardless of the order of terms. That is, the steps may be performed in the same order as the order of terms, or substantially simultaneously performed, or performed in reverse order.

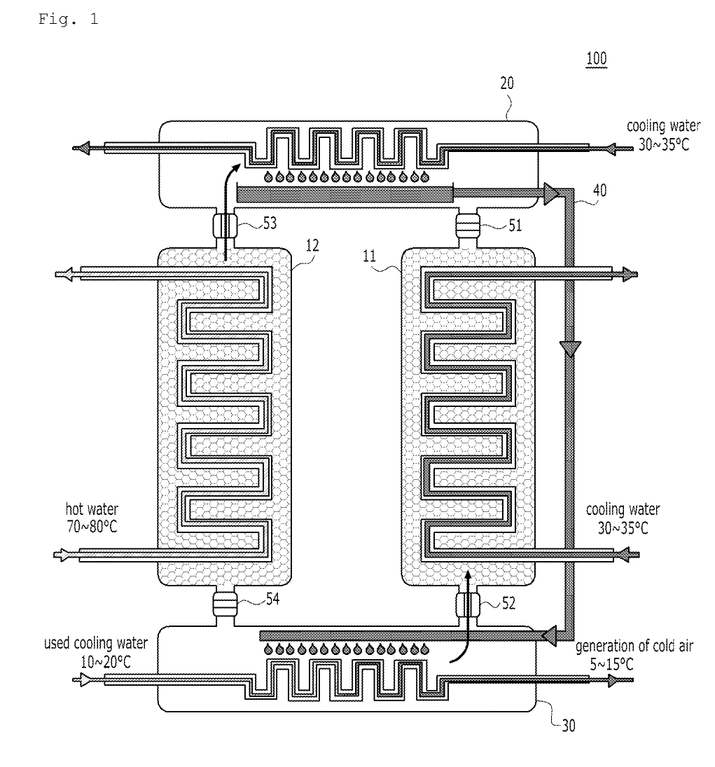

FIG. 1 is a schematic diagram of an adsorption type cooling apparatus 100 according to one embodiment of the invention. In the specification, the adsorption type cooling apparatus 100 includes two adsorption towers 10 (herein, for convenient description, adsorption towers disposed on the right side and the left side of FIG. 1 are respectively referred to as a first adsorption tower 11 and a second adsorption tower 12). However, the construction of the invention is not limited thereto. The number of adsorption towers 10 may vary as necessary. With reference to FIG. 1, the adsorption type cooling apparatus 100 according to one embodiment of the invention is a sealed vacuum apparatus. The adsorption type cooling apparatus 100 includes at least two adsorption towers 10 in which a water vapor adsorbent is contained; a condenser 20 connected to the adsorption towers 10; and an evaporator 30 connected to the adsorption towers 10. The water vapor adsorbent is nanoporous aluminophosphate containing aluminum, phosphorous, and oxygen. The adsorption type cooling apparatus 100 may further include a vacuum pump used to maintain a vacuum degree of the adsorption type cooling apparatus 100.

Each of the adsorption towers 10 includes a heat transfer tube installed therein. The adsorption tower 10 is alternately connected to the condenser 20 and the evaporator 30 via vapor valves 50 such that adsorption and desorption of a refrigerant alternately occur in the adsorption tower 10. According to the embodiment of the invention, water is used as the refrigerant. However, kinds of the refrigerant may vary depending on the adsorbent. In the case of the adsorption type cooling apparatus 100 equipped with two adsorption towers 10 ((herein, the two adsorption towers 10 are respectively referred to as a first adsorption tower 11 and a second adsorption tower for convenient description), when the first adsorption tower undergoes an adsorption operation in which the first adsorption tower 11 is connected to the evaporator 30 to adsorb water vapor and thus cold air is produced by the evaporator 30, the second adsorption tower 12 undergoes a desorption operation (i.e. adsorbent regeneration operation) in which the second adsorption tower 12 is supplied with hot water and thus water vapor is desorbed from the adsorbent and transferred to the condenser 20. The water vapor adsorbent is regenerated through the desorption operation. The adsorption and desorption alternately occur in the adsorption towers 10.

The condenser 20 is connected to one adsorption tower 10 in which the desorption of water vapor is performed, thereby condensing water vapor (moisture) desorbed on the water vapor adsorbent in the adsorption tower 10, using cooling water. The resultant condensate is transferred to the evaporator 30 via a condensate recovery pipe 40 connected between the condenser 20 and the evaporator 30. The evaporator 30 is connected to one adsorption tower 10 in which the adsorption of water vapor is performed. While the recovered condensate (water) vaporizes into water vapor, water supplied to the evaporator 30 is chilled. That is, a chilling effect can be obtained.

According to one embodiment, nanoporous aluminophosphate containing aluminum, phosphorous, and oxygen is used as the water vapor adsorbent. Preferably, nanoporous aluminophosphate (AlPO-34) consisting of aluminum, phosphorous, and oxygen may be used as the water vapor adsorbent. The nanoporous aluminophosphate has a tab density of 0.5 g/cm³ or higher, and may be provided with micropores. Preferably, the micropores have a size of 0.35 to 1.0 nm. More preferably, the micropores have a size of 0.35 to 0.5 nm. In addition, preferably, the micropores may be regularly arranged.

The nanoporous aluminophosphate may have a hierarchically porous structure including micropores and mesopores. In the hierarchically porous structure, pores with various sizes are arranged in multiple stages according to the sizes, or the sizes of the pores are distributed stepwise. Preferably, the hierarchically porous structure may include mesopores and micropores. The size of the mesopores may be within a range of from 3.5 to 25 nm, and the mesopores may be more preferably regularly or randomly arranged.

The nanoporous aluminophosphate has CHA (Chabazite) structure as named by Structure Commission of International Zeolite Association, according to nomenclature of zeolite on the basis of the rules of IUPAC Committee. According to this classification method, framework-type zeolite and crystalline microporous molecular sieve are allocated a code of three characteristics, which is described in the document “Atlas of Zeolite Framework Types, 5th edition, Elsevier, London, England (2001)”.

In addition, the nanoporous aluminophosphate has a high water vapor adsorption performance at room temperatures of 25 to 35° C. unlike conventional water vapor adsorbents and exhibits a high water vapor desorption performance at a relatively low desorption temperature of 70 to 80° C. The dynamic water vapor adsorption capacity of the nanoporous aluminophosphate is about 0.2 g (=0.10 g/cm³, which is a value converted based on tap density) or higher. Here, the dynamic water vapor adsorption capacity means a difference between a water vapor adsorption capacity per 1 g of an adsorbent at a temperature of 30 to 40° C. and a pressure (vapor pressure of relative humidity) of 8 to 15 Torr, and a water vapor adsorption capacity per 1 g of an adsorbent at a temperature of 70 to 80° C. and a pressure (vapor pressure of relative humidity) of 40 to 45 Torr. In the case of the nanoporous aluminophosphate, a high dynamic water vapor adsorption capacity can be obtained because its adsorption performance is similar to that of conventional water vapor adsorbents but desorption of water vapor easily occurs at a relatively low desorption temperature.

The nanoporous aluminophosphate used as the water vapor adsorbent in the invention exhibits a dynamic water vapor adsorption capacity of 0.2 g (i.e. 0.10 g/cm³) or higher even after 100 cycles of adsorption and desorption that are alternately performed by changing temperatures and pressures. That is, the nanoporous aluminophosphate has high durability.

Next, a method of producing the nanoporous aluminophosphate will be described. The nanoporous aluminophosphate can be produced by synthesizing hydrothermally aluminophosphate by blending an aluminum precursor, a phosphine precursor, an amine-based compound, ethylene glycol, and distilled water, by filtering and drying the synthesized aluminophosphate, and by calcinating the aluminophosphate to remove organic species.

The synthesizing is a process of mixing an aluminum precursor, a phosphine precursor, an amine-based compound, ethylene glycol, and distilled water to produce aluminophosphate, and hydrothermal treatment on these mixture. Preferably, the aluminum precursor is first introduced into the distilled water and the distilled is continuously stirred. During the stirring, the phosphine precursor, the amine-based compound, and the ethylene glycol are sequentially introduced into the distilled water. In this process, hydrothermal synthesis is preferably performed at a temperature within a range of from 150 to 300° C. for 72 to 120 hours. When the temperature and time period are outside the above-stated ranges, a reaction does not progress. In this case, porous aluminophosphate cannot be obtained, or no benefit of increased reaction time and temperature can be obtained.

Preferably, as the aluminum precursor, pseudo-boehmite, aluminum isopropoxide, or aluminum hydroxide can be used. As the phosphine precursor, any compound containing phosphorous can be used. However, phospheric acid is preferably used as the phosphine precursor. As the amine-based compound, morpholine or tetraethylammonium hydroxide may be preferably used.

The synthesized aluminophosphate has a composition having a final mole ratio of 1:1 to 1.2:6.0 to 12.0:6.0 to 12.0:20 to 50 (Al₂O₃:P₂O₅:Amine:Ethylene glycol:H₂O) . When the mole ratio of the composition is outside the presented range, aluminophosphate having a structure different from the desired crystalline structure is produced or amorphous aluminophosphate may be produced.

The drying and filtering to obtain the synthesized aluminophosphate are preferably performed by filtering the reacted solution obtained in the synthesizing process, by rinsing the filtered particles with distilled water, and by drying the particles at a temperature within a range of from 80 to 150° C.

The aluminophosphate that is dried in the drying process is subsequently baked at a temperature within a range of from 500 to 700° C. for 1 to 3 hours, to produce nanoporous aluminophosphate. The nanoporous aluminophosphate that has undergone the baking process may be provided with micropores. Alternatively, it may have a hierarchically porous structure including micropores and mesopores.

Next, an operation method of an adsorption type cooling apparatus is described below. For convenient description, a description will be made with reference to the adsorption type cooling apparatus 100 (see FIG. 1) described above, while focusing on the first adsorption tower 11. However, the operation method is not limitedly applied to the adsorption type cooling apparatus 100.

The operation method of an adsorption type cooling apparatus, according to one embodiment of the invention, includes: a process in which water vapor produced from the evaporator moves to the adsorption tower in which the water vapor adsorbent is contained and is adsorbed on the water vapor adsorbent in the adsorption tower; a process in which 70 to 80° C. hot water is supplied to the adsorption tower such that the water vapor adsorbed on the water vapor adsorbent is desorbed; a process in which the desorbed water vapor moves to the condenser and condenses to produce condensate; and a process in which the condensate moves to the evaporator, wherein the water vapor adsorbent is nanoporous aluminophosphate containing aluminum, phosphorus, and oxygen.

Specifically, the operation method of the adsorption type cooling apparatus 100 includes four operation periods. During a first operation period of the four operation periods, a second vapor valve 52 provided on a pipe connected between the first adsorption tower 11 and the evaporator 30 and a third vapor valve 53 provided on a pipe connected between the second adsorption tower 12 and the condenser 20 are opened; a first vapor valve 51 provided on a pipe connected between the first adsorption tower 11 and the condenser 20 and a fourth vapor valve provided on a pipe connected between the second adsorption tower 12 and the evaporator 30 are closed; and cooling water having a temperature of 30 to 35° C. is supplied to the first adsorption tower 11, thereby lowering the temperature of the water vapor adsorbent provided in the first adsorption tower 11 (removal of adsorption heat), such that the water vapor supplied to the first adsorption tower 11 from the evaporator 30 is adsorbed on the water vapor adsorbent. During this operation period, cold air is generated by the evaporator 30 due to latent heat of vaporization. In addition, hot water having a temperature of 70 to 80° C. is supplied to the second adsorption tower 12, thereby heating the water vapor adsorbent contained in the second adsorption tower 12 so that the adsorbed water vapor can be desorbed.

During a second operation period, a preparation process for causing the first adsorption tower 11 to undergo desorption and the second adsorption tower 12 to undergo adsorption is performed. In this operation period, all of the vapor valves 50 are closed to block movement of heat and substances. Then, hot water having a temperature of 70 to 80° C. is supplied to the first adsorption tower 11, thereby heating the inside of the first adsorption tower 11, which raises the vapor pressure of the first adsorption tower 11 to be higher than that of the condenser 20. On the other hand, cold water having a temperature of 30 to 35° C. is supplied to the second adsorption tower 12, thereby lowering the temperature of the second adsorption tower 12, which lowers the internal pressure of the second adsorption tower 12 to be lower than that of the evaporator 30.

During a third operation period, the first vapor valve 51 provided on the pipe connected between the first adsorption tower 11 and the condenser 20 and the fourth vapor valve 54 provided on the pipe connected between the second adsorption tower 12 and the evaporator 30 are opened, and hot water having a temperature of 70 to 80° C. is supplied to the first adsorption tower 11 such that the water vapor is desorbed and then transferred to the condenser 20. In addition, cold water having a temperature of 30 to 35° C. is supplied to the second adsorption tower 12 such that the water vapor transferred from the evaporator 30 is adsorbed on the water vapor adsorbent in the second adsorption tower 12. The water vapor desorbed in the first adsorption tower 11 moves to the condenser 20 and condenses in the condenser 20. At this point, heat of condensation is transferred to the cold water having a temperature of 30 to 35° C. supplied to the condenser 20. The condensed vapor (condensate) is transferred to the evaporator 30 through the condensate recovery pipe 40.

During a fourth operation period, a preparation process for causing the first adsorption tower 11 to undergo adsorption and the second adsorption tower 12 to undergo desorption is performed. That is, all of the vapor valves 50 are closed to block movement of heat and substances. Cold water having a temperature of 30 to 35° C. is supplied to the first adsorption tower 11 to lower the internal temperature of the first adsorption tower 11. Hot water having a temperature of 70 to 80° C. is supplied to the second adsorption tower 12 to increase the internal temperature of the second adsorption tower 12. After the fourth operation period is finished, the first operation period is started again.

According to the embodiment, the water vapor adsorbent is nanoporous aluminophosphate containing aluminum, phosphorous, and oxygen. Preferably, the water vapor adsorbent is nanoporous aluminophosphate (AlPO-34) containing only aluminum, phosphorous, and oxygen and having CHA (Chabazite) structure. Since the water vapor adsorbent is described in detail above when describing the construction of the adsorption type cooling apparatus, a description of the water vapor adsorbent related to the operation method will be omitted here.

Hereinbelow, the advantages of the present invention will be further shown through comparison between an embodiment of the invention and a comparative example. The embodiment is provided to provide help clearer understanding of the invention, and thus should not be construed as limiting the scope of the invention.

### EMBODIMENT

Prepared is an adsorption type cooling apparatus including two adsorption towers containing a water vapor adsorbent, a condenser, and an evaporator, in which the adsorbent is AlPO-34 consisting of only aluminum, phosphorous, and oxygen and having CHA (Chabazite) structure.

### COMPARATIVE EXAMPLE

Prepared is an adsorption type cooling apparatus including two adsorption towers containing a water vapor adsorbent, a condenser, and an evaporator, in the water vapor adsorbent is SAPO-34.

### EXPERIMENTAL EXAMPLE

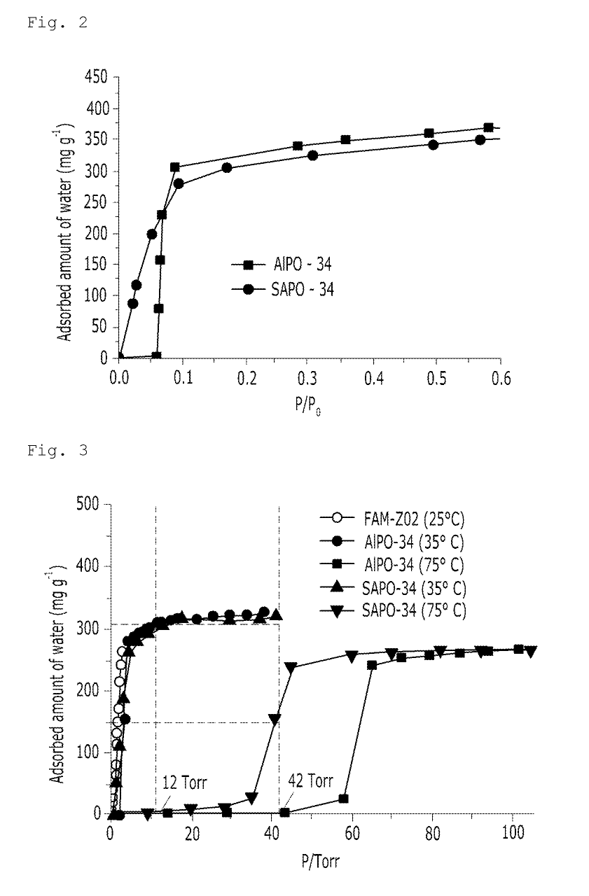

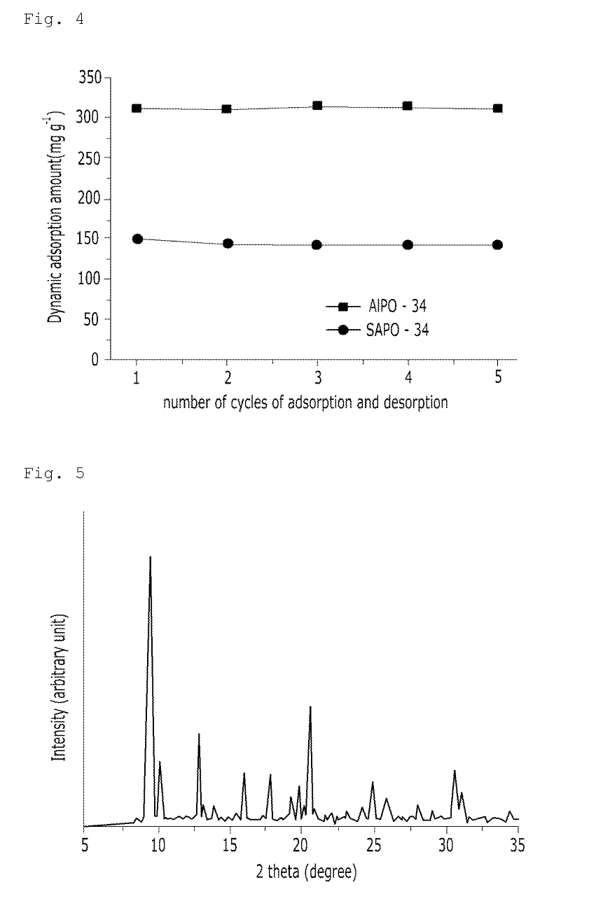

Performances of water vapor adsorbents were compared using the adsorption type cooling apparatuses according to Embodiment and Comparative example. FIG. 2 is a graph illustrating adsorption isotherms of water vapor on AlPO-34 and SAPO-34 at a temperature of 35° C., FIG. 3 is a graph illustrating adsorption isotherms of waver vapor on AlPO-34, SAPO-34, and FAM-Z02 manufactured by Mitsubishi Chemical Ltd. at various temperatures and pressures, and FIG. 4 is a graph illustrating dynamic water vapor adsorption capacities of AlPO-34 and SAPO-34.

Here, AlPO-34 is a new adsorbent that is different from conventional adsorbents and is firstly used as an adsorbent in the present invention. SAPO-34 used in Comparative Example is different from AlPO-34 in the point that it contains silicon. As the results of comparison, SAPO-34 is assumed to be a material having similar adsorptivity and structural performance to FAM-Z02 manufactured by Mitsubishi Chemical Ltd.

As shown in FIG. 2, AlPO-34 and SAPO-34 exhibit similar maximum adsorption amounts of water vapor at 35° C. However, AlPO-34 and SAPO-34 exhibit significantly different adsorption performances under an extremely low pressure condition (i.e. P/PO<0.06). That is, SAPO-34 exhibits a considerably high adsorptivity under such a condition. This means that a large amount of energy is needed to desorb water vapor from SAPO-34 because a large amount of water vapor is strongly adsorbed on SAPO-34. In contrast, AlPO-34 exhibits nearly zero adsorption under an extremely low pressure condition (i.e. P/PO<0.06), but exhibits a high adsorption capacity under a condition in which the vapor pressure P/PO is higher than 0.06. This means that water vapor can be desorbed from SAPO-34 with a much less energy.

With reference to FIG. 3, it is possible to see changes in water vapor adsorption in accordance with pressures at 35° C. and 75° C. With reference to FIG. 4, it is possible to see a dynamic water vapor adsorption capacity that is a difference between an adsorption capacity under conditions of 35° C. (temperature) and 12 Torr (vapor pressure) and an adsorption capacity under conditions of 75° C. (temperature) and 42 Torr (vapor pressure) in an adsorption type cooling apparatus after adsorption and desorption are repeatedly performed. SAPO-34 exhibits a low dynamic water vapor adsorption capacity of 0.14 g-water/g-sorbent when adsorption is performed under conditions of 35° C. and 12 Torr (vapor pressure) and desorption is performed under conditions of 75° C. and 42 Torr (vapor pressure). However,

AlPO-34 exhibits a much higher dynamic water vapor adsorption capacity of 0.31 g-water/g-sorbent. This dynamic water vapor adsorption capacity is a value similar to the maximum water vapor adsorption amount (at 35° C.) of AlPO-34. This means that unlike SAPO-34, water vapor adsorbed on AlPO-34 can be mostly desorbed at a relatively low desorption temperature, i.e. 75° C., and a vapor pressure of 42 Torr (see FIG. 3). In contrast, as shown in FIG. 3, SAPO-34 exhibits a high dynamic water vapor adsorption capacity of 0.15 g-water/g-sorbent even at a desorption temperature of 75° C. and a vapor pressure of 42 Torr. This means that SAPO-34 is inferior to AlPO-34 in terms of the dynamic water vapor adsorption capacity under the conditions described above. Accordingly, it is possible to confirm that AlPO-34 can be usefully used in an adsorption type cooling apparatus.

Although only some of the embodiments conceived by the inventors have been described in the specification, the technical spirit of the invention is not limited to the embodiments described herein, but those skilled in the art will appreciate that the invention can be embodied in various embodied in many different forms, without departing from the scope and spirit of the invention as disclosed in the accompanying claims.

1. An adsorption type cooling apparatus comprising:
at least two adsorption towers provided with a water vapor adsorbent contained therein;
a condenser alternately connected to the adsorption towers; and
an evaporator alternately connected to the adsorption towers,
wherein the water vapor adsorbent is nanoporous aluminophosphate containing aluminum, phosphorous, and oxygen.

2. The adsorption type cooling apparatus according to claim 1, wherein the water vapor adsorbent is provided with micropores.

3. The adsorption type cooling apparatus according to claim 2, wherein the micropores have a size of 0.35 to 1.0 nm.

4. The adsorption type cooling apparatus according to claim 2, wherein the micropores are regularly arranged.

5. The adsorption type cooling apparatus according to claim 2, wherein the water adsorbent is provided with mesopores and has a hierarchically porous structure.

6. The adsorption type cooling apparatus according to claim 5, wherein the mesopores have a size of 3.5 to 25 nm.

7. The adsorption type cooling apparatus according to claim 5, wherein the mesopores are regularly or randomly arranged.

8. The adsorption type cooling apparatus according to claim 1, wherein the water vapor adsorbent exhibits a dynamic water vapor adsorption capacity of 0.2 g-water/g-sorbent or higher, wherein the dynamic water vapor adsorption capacity refers to a difference between an adsorption capacity of water vapor per 1 g of the water vapor adsorbent at a temperature of 25 to 35° C. and a vapor pressure of 8 to 15 Torr, and an adsorption capacity of water vapor per 1 g of the water vapor adsorbent at a temperature of 70 to 80° C. and a vapor pressure of 40 to 45 Torr.

9. An operation method of an adsorption type cooling apparatus, the method comprising:
transferring water vapor vaporized in an evaporator to an adsorption tower in which a water vapor adsorbent is contained such that the water vapor is adsorbed on the water vapor adsorbent in the adsorption tower;
supplying 70 to 80° C. hot water to the adsorption tower such that the water vapor is desorbed from the water vapor absorbent;
transferring the desorbed water vapor to a condenser such that the water vapor condenses in the condenser to produce condensate; and
transferring the condensate to the evaporator,
wherein the water vapor adsorbent is nanoporous aluminophosphate containing aluminum, phosphorous, and oxygen.

10. The operation method according to claim 9, wherein the water vapor adsorbent is provided with micropores.

11. The operation method according to claim 10, wherein the micropores have a size of 0.35 to 1.0 nm.

12. The operation method according to claim 10, wherein the micropores are regularly arranged.

13. The operation method according to claim 10, wherein the water vapor adsorbent is provided with mesopores and has a hierarchically porous structure.

14. The operation method according to claim 13, wherein the mesopores have a size of 3.5 to 25 nm.

15. The operation method according to claim 13, wherein the mesopores are regularly or randomly arranged.

16. The operation method according to claim 9, wherein the water vapor adsorbent exhibits a dynamic water vapor adsorption capacity of 0.2 g-water/g-sorbent or higher, wherein the dynamic water vapor adsorption capacity is a difference between an adsorption capacity of water vapor per 1 g of the water vapor adsorbent at a temperature of 30 to 40° C. and a vapor pressure of 8 to 15 Torr, and an adsorption capacity per 1 g of the water vapor adsorbent at a temperature of 70 to 80° C. and a vapor pressure of 40 to 45 Torr.
